(19) United States
(12) Patent Application Publication
(10) Pub. No.: US 2012/0125368 A1
(43) Pub. Date: May 24, 2012

(54) LIQUID PROCESSING METHOD, LIQUID PROCESSING APPARATUS AND STORAGE MEDIUM STORING PROGRAM FOR PERFORMING LIQUID PROCESSING METHOD

(75) Inventors: Miyako KANEKO, Nirasaki City (JP); Yasushi FUJII, Nirasaki City (JP); Kenji SEKIGUCHI, Nirasaki City (JP)

(73) Assignee: TOKYO ELECTRON LIMITED, Tokyo (JP)

(21) Appl. No.: 13/300,739

(22) Filed: Nov. 21, 2011

(30) Foreign Application Priority Data
Nov. 22, 2010 (JP) 2010-260411
Aug. 22, 2011 (JP) 2011-180892

(51) Int. Cl. B08B 3/08; B08B 7/04

(52) U.S. Cl. 134/18; 134/36; 134/105

(57) ABSTRACT

There are provided a liquid processing method and a liquid processing apparatus capable of removing a resist film without removing an underlying film when removing the resist film from a substrate on which the underlying film and the resist film are formed in sequence from the bottom and into which ions have been previously implanted. In the liquid processing method capable of processing a substrate by a processing solution, the method includes removing the resist film from the substrate by supplying the processing solution at a temperature of about 120° C. or higher to the substrate. The processing solution includes a sulfuric acid and a nitric acid at a preset ratio, and the substrate has thereon the underlying film and the resist film formed on the underlying film, and ions have been previously implanted into the substrate.

### CROSS-REFERENCE TO RELATED APPLICATION

This application claims the benefits of Japanese Patent Application Nos. 2010-260411 and 2011-180892 filed on Nov. 22, 2010 and Aug. 22, 2011, respectively. The entire disclosures of which are incorporated herein by reference in their entirety.

### FIELD OF THE INVENTION

The present disclosure relates to a liquid processing method for processing a substrate by a processing solution, a liquid processing apparatus and a storage medium storing a program for performing the liquid processing method.

### BACKGROUND OF THE INVENTION

In a manufacturing process of a semiconductor device or a flat panel display (FPD), a process performed by supplying a processing solution to various substrates such as a semiconductor wafer, a glass substrate, and the like is widely used. Such a process includes, for example, a cleaning process for removing a resist film formed on a substrate or the like.

As for a liquid processing apparatus for performing the above-mentioned process such as the cleaning process or the like on the substrate, there has been used a single wafer type liquid processing apparatus for processing a single substrate at a time and a batch type liquid processing apparatus for processing multiple substrates at a time.

For example, in order to form a MOS structure on a substrate, a gate insulating film is formed on a semiconductor layer and, thereafter, a gate electrode is formed on the gate insulating film. Next, ions are implanted into the semiconductor layer through the gate insulating film with the gate electrode as a mask. At this time, a resist film is formed in advance on a part of the substrate so as to coat a portion where ion implantation is not required. The ion implantation is performed after the resist film is formed. Further, the resist film is removed from the substrate by processing the substrate by a liquid processing apparatus.

As the liquid processing apparatus for removing the resist film from the substrate, there has been known an apparatus for performing a so-called SPM cleaning for removing the resist film by supplying, as a processing solution, a mixed solution including sulfuric acid and oxygenated water onto the substrate (see, e.g., Patent Document 1). In the example described in Patent Document 1, it is described that a mixed solution including sulfuric acid, whose temperature is 170° C. or higher, and oxygenated water is supplied onto a surface of the substrate. Here, a flow rate ratio of the sulfuric acid to the oxygenated water is about 1:0.1 to about 1:0.35.
Patent Document 1: Japanese Patent Laid-open Publication No. 2009-016497.

However, the liquid processing method performed by the above-mentioned liquid processing apparatus has the following drawbacks.

When the resist film is removed by supplying the mixed solution including sulfuric acid and oxygenated water (hereinafter, referred to as a ‘sulfuric acid oxygenated water’) onto the substrate on which the gate insulating film and the resist film are formed in sequence and into which ions have been previously implanted, the gate insulating film as well as the resist film are removed by etching. As a result, the film thickness of the gate insulating film may be decreased.

In order to prevent the thickness of the gate insulating film from being decreased, it is considered to decrease the etching rate of the gate insulating film by the sulfuric acid oxygenated water by reducing concentration of the sulfuric acid oxygenated water or by reducing a mixture ratio of the sulfuric acid to the oxygenated water. However, if the etching rate of the gate insulating film is decreased, the resist film cannot be completely removed. Especially, the resist film into which ions are implanted is not easily removed by the sulfuric acid oxygenated water.

Moreover, the above-described problem may occur when the resist film is removed from the substrate on which the gate insulating film and the resist film are formed in sequence from the bottom and into which ions have been previously implanted. Further, the above-described problem may also occur when the resist film is removed from the substrate on which one of various underlying films and a resist film are formed in sequence from the bottom and into which ions have been previously implanted.

### BRIEF SUMMARY OF THE INVENTION

In view of the above, the present disclosure provides a liquid processing method and a liquid processing apparatus capable of removing a resist film without removing an underlying film when removing the resist film from the substrate on which the underlying film and the resist film are formed in sequence from the bottom and into which ions have been previously implanted.

In order to solve the above-described problem, the present disclosure provides the following means which will be described below.

In accordance with an aspect of the present disclosure, there is provided a liquid processing method for processing a substrate by a processing solution. The liquid processing method includes removing a resist film from the substrate by supplying a processing solution at a temperature of about 120° C. or higher to the substrate. Here, the processing solution includes a sulfuric acid and a nitric acid at a preset ratio. Further, the substrate has thereon a underlying film and the resist film formed on the underlying film, and ions have been previously implanted into the substrate.

In accordance with another aspect of the present disclosure, there is provided a liquid processing method for processing a substrate by a processing solution. The liquid processing method includes supporting the substrate by a substrate supporting unit; generating a processing solution by mixing a sulfuric acid and a nitric acid mixed at a preset ratio in a mixing unit; and removing a resist film from the substrate by supplying the processing solution at a temperature of about 120° C. or higher to the substrate from a supply unit. Here, the substrate has thereon a underlying film and the resist film formed on the underlying film, and ions have been previously implanted into the substrate.

In accordance with still another aspect of the present disclosure, there is provided a liquid processing apparatus for processing a substrate by a processing solution. The apparatus includes a substrate supporting unit for supporting a substrate; a mixing unit for mixing a sulfuric acid and a nitric acid; a supply unit for supplying, as a processing solution, the sulfuric acid and the nitric acid mixed by the mixing unit to the substrate; a heating unit for heating the sulfuric acid or the processing solution to a predetermined temperature; and a controller for controlling the substrate supporting unit, the mixing unit, the supply unit and the heating unit. The controller controls the substrate supporting unit to support the substrate; controls the mixing unit to mix the sulfuric acid and the nitric acid at a preset ratio; controls the supply unit to supply the mixture of the sulfuric acid and the nitric acid at a temperature of about 120° C. or higher to the substrate; and controls the heating unit to heat the sulfuric acid or the processing solution. Further, the substrate has thereon a underlying film and the resist film formed on the underlying film, and ions have been previously implanted into the substrate.

In accordance with the present disclosure, when the resist film is removed from the substrate on which the underlying film and the resist film are formed in sequence and into which ions have been previously implanted, the resist film can be removed without removing the underlying film.

### BRIEF DESCRIPTION OF THE DRAWINGS

Non-limiting and non-exhaustive embodiments will be described in conjunction with the accompanying drawings. Understanding that these drawings depict only several embodiments in accordance with the disclosure and are, therefore, not to be intended to limit its scope, the disclosure will be described with specificity and detail through use of the accompanying drawings, in which:

FIG. 1 is a view showing a schematic configuration of a liquid processing apparatus in accordance with a first embodiment of the present disclosure;

FIG. 2 shows cross sectional views showing a wafer state in each process of a liquid processing method in accordance with the first embodiment;

FIG. 3 is a graph of a decreased amount of an underlying film thickness when removing the resist film in case of a comparative example 1 (SPM cleaning) and a test example 2 (mixed acid cleaning);

FIG. 4 is a graph of etching rates of various underlying films at various temperatures of the processing solution when removing a resist film in a test example 3 (mixed acid cleaning);

FIG. 5 is a view showing a schematic configuration of a liquid processing apparatus in accordance with a first modification of the first embodiment;

FIG. 6 is a view showing a schematic configuration of a liquid processing apparatus in accordance with a second modification of the first embodiment; and

FIG. 7 is a view showing a schematic configuration of a liquid processing apparatus in accordance with a second embodiment.

### DETAILED DESCRIPTION OF THE INVENTION

Hereinafter, the embodiments of the present disclosure will be described in detail with reference to the accompanying drawings.

### First Embodiment

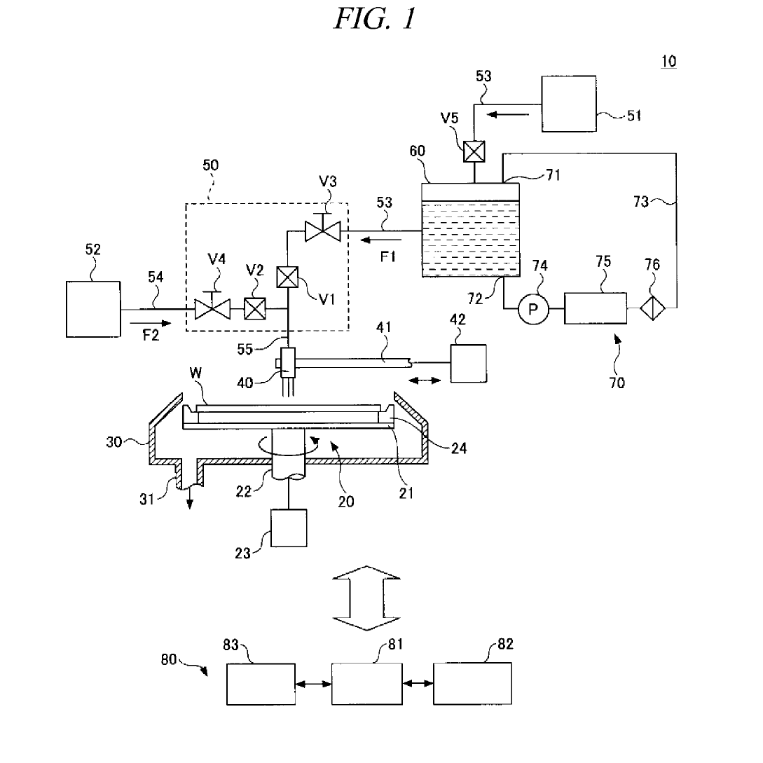

First, a liquid processing apparatus in accordance with a first embodiment of the present disclosure will be described with reference to FIG. 1.

FIG. 1 is a view showing a schematic configuration of a liquid processing apparatus in accordance with the present embodiment.

In accordance with the present embodiment, as a liquid processing apparatus, a single-wafer liquid processing apparatus for processing a substrate to be processed W (hereinafter, referred to as ‘substrate’ or ‘wafer’) one by one is used.

The liquid processing apparatus 10 includes a wafer supporting unit 20, a liquid drain cup 30, a supply nozzle 40, a switching unit 50, a first supply source 51, a second supply source 52, a storage tank 60, a circulation device 70, and a controller 80.

The wafer supporting unit 20 includes a rotation plate 21, a rotation shaft 22, and a rotating motor 23. The wafer supporting unit 20 rotatably supports the wafer W.

A supporting member 24 for supporting a periphery portion of the wafer W is provided at the rotation plate 21. Accordingly, the wafer W is supported by the supporting member 24. The rotation shaft 22 is fixed to a lower portion of the rotation plate 21. Further, the rotation shaft 22 is connected to the rotating motor 23 via a driving force transmission mechanism, e.g., a pulley, a belt, etc. The rotation shaft 22 is driven to be rotated by the rotating motor 23.

Further, the wafer supporting unit 20 corresponds to a substrate supporting unit in the present disclosure.

The liquid drain cup 30 is provided so as to surround the wafer supporting unit 20. A liquid drain pipe 31 is connected to a bottom of the liquid drain cup 30. A liquid drain switching unit (not shown) is connected to the liquid drain pipe 31, so that the liquid drain is performed separately depending on the kind of a processing solution.

The supply nozzle 40 supplies the processing solution onto the wafer W. The supply nozzle 40 is supported by a nozzle arm 41. The nozzle arm 41 is driven to be moved by a driving mechanism 42. The supply nozzle 40 can be moved between a processing solution supply position above the wafer W and a retreated position by moving the nozzle arm 41 by the driving mechanism 42. In this manner, the processing solution can be supplied onto the wafer W.

Further, the supply nozzle 40 corresponds to a supply unit in the present disclosure.

The switching unit 50 switchably connects the first supply source 51 and the second supply source 52 to the supply nozzle 40.

The first supply source 51 supplies sulfuric acid. The second supply source 52 supplies nitric acid. The first supply source 51 is connected to the switching unit 50 via a first supply path 53. The second supply source 52 is connected to the switching unit 50 via a second supply path 54. The switching unit 50 is connected to the supply nozzle 40 via a third supply path 55.

Moreover, sulfuric acid of, e.g., about 96 wt % may be used, and nitric acid of, e.g., about 61 wt % may be used.

The switching unit 50 has valves V1, V2, V3 and V4. The valve V1 is provided on the first supply path 53. The valve V2 is provided on the second supply path 54. The valves V1 and V2 are provided to be openable/closable independently. The valve V3 is provided on the first supply path 53 at the upstream side of the valve V1. The valve V4 is provided on the second supply path 54 at the upstream side of the valve V2. The valves V3 and V4 are configured to independently control the opening degrees thereof.

By switching the opening/closing of the valves V1 and V2 independently and controlling the opening degrees of the valves V3 and V4 independently, the switching unit 50 can mix the sulfuric acid supplied by the first supply source 51 and the nitric acid supplied by the second supply source 52 at a certain ratio. The volume ratio of the sulfuric acid to the nitric acid may be set to be e.g., about 2:1 to about 50:1.

Further, in the present disclosure, the switching unit 50 corresponds to a mixing unit. In addition, instead of the valves V3 and V4, it is possible to use various flow rate controllers such as LFC, MFC or the like.

The storage tank 60 is provided on the first supply path 53 between the first supply source 51 and the switching unit 50. The storage tank 60 is configured to store therein the sulfuric acid supplied by the first supply source 51. Further, a valve V5 is provided on the first supply path 53 between the first supply source 51 and the storage tank 60. The valve V5 is provided to be openable/closable.

The circulation device 70 has a supply port 71, an outlet port 72, a circulation path 73, a pump 74, a heater 75 and a filter 76. The supply port 71 is formed at, e.g., an upper portion of the storage tank 60. The outlet port 72 is formed at, e.g., a bottom portion of the storage tank 60. The circulation path 73 connects the outlet port 72 and the supply port 71 of the storage tank 60. The pump 74, the heater 75 and the filter 76 are provided on the circulation path 73 in sequence from the outlet port 72 side, for example. The pump 74 serves as a liquid transporting unit for transporting the sulfuric acid from the storage tank 60 to the supply port 71. The heater 75 is configured to heat the sulfuric acid transported to the supply port 71 to a certain temperature. That is, the heater 75 serves as a heating unit for controlling a processing solution at a certain temperature. The controlled temperature may be, e.g., about 120° C. to about 250° C. The filter 76 serves as a purifying unit for purifying the processing solution transported from the storage tank 60.

The circulation device 70 discharges the sulfuric acid from the outlet port 72 of the storage tank 60 by the pump 74. Next, the discharged sulfuric acid is heated by the heater 75 and, then, the heated sulfuric acid is purified by the filter 76. Thereafter, the purified sulfuric acid is transported to the supply port 71 by the pump 74. Next, the transported sulfuric acid is introduced to the storage tank 60 again through the supply port 71. In this manner, the sulfuric acid is circulated.

The circulation device 70 can transport the sulfuric acid at a certain flow rate of, e.g., about 10 L/min (circulation flow rate) from the outlet port 72 to the supply port 71 by the pump 74.

Further, a pure water supply source (not shown) may be connected on the third supply path 55 between the switching unit 50 and the supply nozzle 40 via a switching unit (not shown). Alternatively, a pure water supply nozzle (not shown) different from the supply nozzle 40 may be provided and the pure water supply source (not shown) may be connected to the pure water supply nozzle. In this way, a pure water rinsing can be performed after performing the process using the processing solution in the liquid processing apparatus 10.

Further, a second supply nozzle different from the supply nozzle 40 and a collecting unit (not shown) for connecting the liquid drain pipe 31 and the second supply nozzle may be provided. The collecting unit may collect the processing solution from the liquid drain pipe 31 by a pump (not illustrated), and the collected processing solution may be purified by a filter (not shown). Then, the purified processing solution may be transported to the second supply nozzle by the non-illustrated pump (not shown), and then, be supplied onto the wafer W again.

The controller 80 includes a process controller 81 having a microprocessor (computer). The process controller 81 has a key board through which a process manager inputs commands for controlling each component of the liquid processing apparatus 10. Further, connected to the controller 80 is a user interface 82 including a display for visually displaying an operation state of each component of the liquid processing apparatus 10. Further, connected to the process controller 81 is a storage unit 83 for storing therein control programs for performing various processes performed in the liquid processing apparatus 10 under the control of the process controller 81 or control programs for allowing each component of the liquid processing apparatus to perform a certain process according to a processing condition, i.e., processing recipes. The recipes are stored in a storage medium (recording medium) in the storage unit 83. The storage medium may be a hard disk or a semiconductor memory. Further, the recipes may be transmitted appropriately via, e.g., a dedicated line from another apparatus.

If necessary, any one of the recipes may be read out from the storage unit 83 in response to an instruction inputted from the user interface 82 and executed by the process controller 81. Accordingly, a desired process is performed in the liquid processing apparatus 10 under the control of the process controller 81.

Hereinafter, the liquid processing method of the present embodiment will be described. In accordance with the liquid processing method of the present embodiment, the resist film is removed from the wafer W on which the underlying film and the resist film are formed in sequence from the bottom and into which ions have been previously implanted.

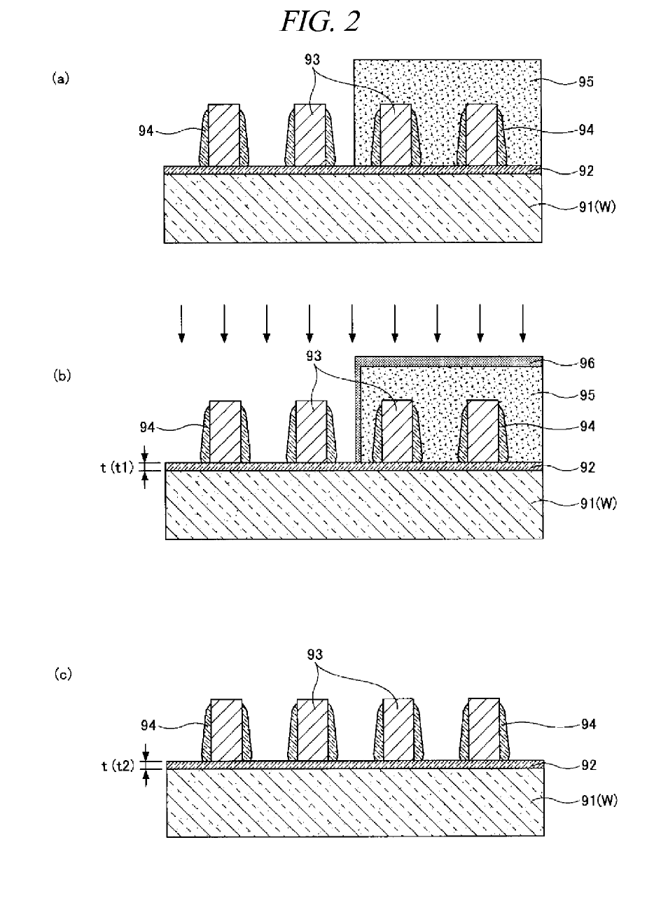

FIG. 2 shows cross sectional views showing the wafer states in each process of the liquid processing method of the present embodiment.

A substrate on which an underlying film was formed in advance is prepared. Here, for example, a wafer W having thereon a MOS (Metal Oxide Semiconductor) structure is prepared.

First, the wafer W having thereon a semiconductor layer 91 is prepared. A gate insulating film 92 is formed on the semiconductor layer 91 and, then, a gate electrode 93 is formed on the formed gate insulating film 92. The gate electrode 93 may be formed by forming an electrode film on the gate insulating film 92; forming a resist pattern by, e.g., a photolithography technique; and etching the electrode film by using the resist pattern as a mask. Next, an insulating film is formed so as to cover a side surface of the gate electrode 93. By performing anisotropic etching on the insulating film in a direction perpendicular to the wafer W, a sidewall film 94 that covers the side surface of the gate electrode 93 can be formed.

When the semiconductor layer 91 is made of silicon (Si), a silicon oxide film (SiO₂ film) formed by, e.g., thermal oxidation or a silicon oxynitride film (SiON film) formed by, e.g., plasma nitrification of a silicon oxide film may be used as the gate insulating film 92. As for the sidewall film 94, there may be used a silicon nitride film (SiN film) or a silicon oxide film (SiO₂ film) formed by, e.g., atomic layer deposition (ALD).

Thereafter, as shown in FIG. 2(a), a resist film 95 is formed on the gate insulating film 92 on the wafer W. Before ion implantation illustrated in FIG. 2(b) is carried out, the resist film 95 is formed on a part of the wafer W so as to cover a portion where ion implantation is not required.

Then, as shown in FIG. 2(b), ions such as arsenic (As) or the like are implanted in a state where the resist film 95 has been previously formed. In the portion where the resist film 95 is not formed, ions are implanted into the semiconductor layer 91 through the gate insulating film 92 by using the gate electrode 93 and the sidewall film 94 as a mask. Meanwhile, in the portion where the resist film is formed, ions are implanted into the resist film 95 without being implanted into the semiconductor layer 91. As a consequence, a hardened layer 96 is formed on the surface of the resist film 95.

A dose of ions implanted into the wafer W is desirably larger than or equal to about 10¹⁴ ions/cm², and more desirably larger than or equal to about 10¹⁵ ions/cm². If the dose is larger than about 10¹⁴ ions/cm², the hardened layer 96 formed on the resist film 95 becomes relatively thick and hard. Therefore, in case of using a sulfuric acid oxygenated water, the resist film 95 cannot be removed without removing the gate insulating film 92 and the sidewall film 94. However, in case of using a processing solution including sulfuric acid and nitric acid, the resist film 95 can be removed without removing the gate insulating film 92 and the sidewall film 94.

Next, as shown in FIG. 2(c), the resist film 95 is removed from the wafer W into which ions have been previously implanted.

The wafer W is supported by the supporting member 24 of the wafer supporting unit 20. The wafer W supported by the supporting member 24 is rotated by rotating the rotation shaft 22 and the rotation plate 21 through the rotating motor 23. The supply nozzle 40 is moved to the processing solution supply position by the driving mechanism 42. Then, the processing solution is supplied onto the wafer W via the supply nozzle 40.

The controller 80 is configured to control the heater 75 to heat the sulfuric acid such that the temperature of the processing solution supplied onto the wafer W becomes higher than or equal to about 120° C. For example, a temperature sensor (not shown) is installed near the supply nozzle 40. Then, the temperature of the processing solution supplied via the supply nozzle 40 is measured by the temperature sensor. Further, the controller 80 controls power supplied to the heater 75 such that the temperature measured by the temperature sensor becomes higher than or equal to about 120° C.

The sulfuric acid is heated by the heater 75 while flowing through the circulation path 73. Hence, the sulfuric acid stored in the storage tank 60 is maintained at a certain temperature higher than or equal to about 120° C. For example, when the nitric acid supplied by the second supply source 52 is not heated, the sulfuric acid stored in the storage tank 60 may be maintained at a temperature higher than a preset temperature of the processing solution supplied by the supply nozzle 40.

Further, the controller 80 can adjust the supplement amount of sulfuric acid to the storage tank 60 from the first supply source 51 by controlling opening/closing of the valve V5. As a result, the controller 80 may adjust the amount (storage amount) of sulfuric acid stored in the storage tank 60 to be maintained at a constant value.

The controller 80 supplies the sulfuric acid at a first flow rate F1 from the storage tank 60 by opening the valve V1 and by controlling an opening degree of the valve V3. The sulfuric acid is stored in the storage tank 60 at a temperature which allows the processing solution supplied by the supply nozzle 40 to be about 120° C. or higher. Moreover, the controller 80 supplies the nitric acid at a second flow rate F2 from the second supply source 52 by opening the valve V2 and by controlling an opening degree of the valve V4. At this time, the opening degrees of the valves V3 and V4 are adjusted such that a ratio of the first flow rate F1 to the second flow rate F2 may have a certain value. As a result, the sulfuric acid and the nitric acid mixed at the mixture ratio by the switching unit 50 can be supplied, as a processing solution having a temperature of about 120° C. or higher, onto the wafer W by the supply nozzle 40.

As shown in FIG. 2(c), the resist film 95 is removed from the wafer W by supplying the processing solution onto the wafer W. At this time, the resist film 95 can be removed without removing the gate insulating film 92 and the sidewall film 94.

It is desirable that the controller 80 controls the switching unit 50 such that the sulfuric acid and the nitric acid are mixed at a volume ratio of about 2:1 to about 50:1. In other words, it is desirable to mix the sulfuric acid and the nitric acid such that the ratio of the first flow rate F1 to the second flow rate F2 is about 2:1 to about 50:1. When the mixture ratio of the nitric acid is larger than a case where the sulfuric acid and the nitric acid are mixed at a ratio of about 2:1, it is difficult to handle the nitric acid due to inflammability thereof. When the mixture ratio of the nitric acid is smaller than a case where the sulfuric acid and the nitric acid are mixed at a ratio of about 50:1, the resist film 95 may not be removed.

It is desirable that the controller 80 controls the heater 75 such that the temperature of the supplied processing solution becomes about 120° C. to about 250° C. When the temperature of the processing solution is lower than about 120° C., the resist film 95 may not be removed. On the other hand, when the temperature of the processing solution is higher than about 250° C., the heat resistance of each component of the liquid processing apparatus 10 may not be ensured.

It is desirable that the controller 80 controls the switching unit 50 such that the mixture of sulfuric acid and nitric acid serving as the processing solution is supplied for about 2 minutes (processing time). The reason why the processing time of about 2 minutes is required will be described below with reference to Table 1.

Thereafter, a pure water rinsing process is performed by supplying pure water onto the wafer W from a pure water supply source (not shown) via the supply nozzle 40 or from a pure water supply source (not shown) via a pure water supply nozzle (not shown). Next, the cleaning process is completed by performing a spin dry or a N₂ dry, if necessary.

Here, a test for examining whether or not the resist film would be removable by performing liquid processing method is performed as a test example 1 while changing a mixture ratio of the sulfuric acid to the nitric acid, a temperature of a processing solution, and a processing pressure. The result thereof is shown in Table 1. The test shown in Table 1 is performed under a condition that a thickness of the resist film is about 0.5 μm.

TABLE 1

| Mixture ratio | Temperature of | Processing | Removal |
|---|---|---|---|
| of sulfuric acid | a processing | time | state of |
| to nitric acid | solution (° C.) | (minute) | resist film |
| 2:1 | 80 | 10 | X |
| | 120 | | ◯ |
| 3:1 | 120 | | ◯ |
| | 150 | | ◯ |
| 4:1 | 150 | 10 | ◯ |
| | | 5 | ◯ |
| | | 3 | Δ |
| | | 1 | Δ |
| | | 0.5 | Δ |
| | 170 | 10 | ◯ |
| | 200 | 10 | ◯ |
| | | 5 | ◯ |
| | | 3 | Δ |
| | | 1 | Δ |
| | | 0.5 | Δ |
| | 250 | 3 | ◯ |
| | | 1 | ◯ |
| | | 0.5 | ◯ |
| 10:1 | 150 | 10 | ◯ |
| | | 5 | ◯ |
| | | 3 | Δ |
| | | 1 | Δ |
| | | 0.5 | Δ |
| | 170 | 10 | ◯ |
| | 200 | 10 | ◯ |
| | | 5 | ◯ |
| | | 3 | ◯ |
| | | 1 | ◯ |
| | | 0.5 | Δ |
| 20:1 | 200 | 10 | ◯ |
| 50:1 | 200 | 10 | ◯ |

◯ Removable
Δ partially removable
X non-removable

Table 1 shows the mixture ratio of the sulfuric acid to the nitric acid, the temperature of the processing solution, the processing time, and the removal state of the resist film. Further, the notations ◯, Δ, and X in the removal state of the resist film indicate a removable state, a partially removable state, and a non-removable state, respectively.

The result described in Table 1 shows that when the mixture ratio of the sulfuric acid to the nitric acid is about 2:1 to about 50:1 at a volume ratio and the temperature of the processing solution is higher than or equal to about 120° C., the resist film can be removed by performing the liquid processing method for about 2 minutes or more. Especially, a resist film can be removed more easily as the temperature of the processing solution is increased (about 200° C. or higher). The resist film can be removed more easily especially when the mixture ratio of the sulfuric acid to the nitric acid is about 4:1 to 10:1. Accordingly, desirably, the mixture ratio of the sulfuric acid to the nitric acid as the processing solution is about 2:1 to about 50:1, and more desirably about 4:1 to about 10:1. In addition, the temperature of the supplied processing solution is desirably set to be about 120° C. to about 250° C. in order to ensure the heat resistance of each component of the liquid processing apparatus. Besides, the processing time is desirably set to be about 2 minutes or more.

When the resist film is removed by the processing solution containing the sulfuric acid and the nitric acid, and maintained at the temperature of about 120° C. or higher, the operation principle capable of removing the resist film without removing the gate insulating film and the sidewall film can be described as follows.

In the following description, the mixture obtained by mixing the sulfuric acid and the nitric acid is referred to as “mixed acid”, and a cleaning process using the mixed acid is referred to as “mixed acid cleaning”. Moreover, a cleaning process using a sulfuric acid oxygenated water is referred to as “SPM cleaning”. The mixed acid cleaning and the SPM cleaning will be described in comparison with each other.

In the SPM cleaning, when the sulfuric acid and the oxygenated water are mixed, the reaction described in the following Eq. (1) occurs.

H₂SO₄+H₂O₂→H₂SO₅+H₂O Eq. (1)

As a consequence, Caro's acid (H₂SO₅) is produced. Caro's acid (H₂SO₅) according to Eq. (1) produces OH radicals (OH.) by the reaction described in the following Eq. (2).

H₂SO₅→HSO₄.+OH. Eq. (2)

The OH radicals (OH.) reacts with a silicon oxide film (SiO₂) by the reaction described in the following Eq. (3).

SiO₂+4OH+4H→Si(OH)₄+2H₂O Eq. (3)

As a consequence, the silicon oxide film (SiO₂) is etched. As described above, in the SPM cleaning, when the resist film is removed, it may be considered that the sidewall film and the underlying film such as the gate insulating film or the like are also etched.

Meanwhile, in the mixed acid cleaning, when the sulfuric acid and the nitric acid are mixed, the reaction described in the following Eq. (4) occurs. As a consequence, nitronium ions (NO₂⁺) are produced.

2H₂SO₄+HNO₃→NO₂⁺+2HSO₄⁻+H₃O⁺ Eq. (4)

For example, since nitronium ions (NO₂⁺) serve as a strong electrophile, R—H bonds (R being various functional groups and H being a hydrogen atom) of the resist film and the hardened layer are nitrided. Therefore, an aromatic nitro compound shown in the following structural formula (5) is produced.

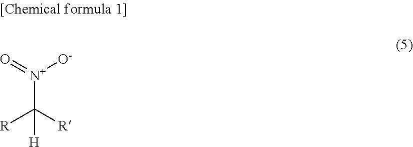

The produced aromatic nitro compound reacts with the nitric acid. Hence, carbanion shown in the following structural formula (6) is produced.

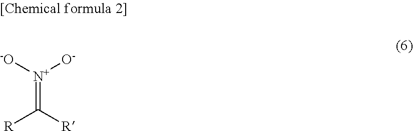

At this time, since the nitric acid is a base, it reacts with the aromatic nitro compound. The produced carbanion reacts with the sulfuric acid. As a consequence, ketone and aldehyde shown in the following structural formula (7) are produced.

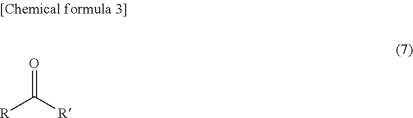

At this time, the sulfuric acid as an acid reacts with the carbanion. The aldehyde is water-soluble whereas the ketone shown in the structural formula (7) is insoluble in water. However, the ketone shown in the structural formula (7) is additionally oxidized by the sulfuric acid and turned into carboxylic acid to be water-soluble. Accordingly, it is considered that the resist film can be removed from the wafer W by these reactions. Furthermore, it is considered that the reaction rate is sufficiently increased at a temperature of about 120° C. or higher.

For example, it is considered that since the nitronium ions (NO₂⁺) act as an oxidizing agent, the resist film can be removed from the wafer W by oxidizing the resist film and the hardened layer and by cutting the bonds between carbon atoms such as C—C single bonds, C═C double bonds and the like. Moreover, it is considered that the reaction rate is sufficiently increased at the temperature of about 120° C. or higher.

Meanwhile, the products generated by Eq. (4) including the nitronium ions (NO₂⁺) may not be easily reacted with, e.g., a silicon oxide film (SiO₂ film), compared to OH radicals (OH.).

Therefore, the resist film may be removed without removing the underlying film and the sidewall film by supplying onto the wafer W the mixed acid maintained at a temperature of about 120° C. or higher.

The same effects as those of the present embodiment can be obtained even in a case where a processing solution including various acids capable of generating the nitronium ions (NO₂⁺), instead of the mixed acid containing the sulfuric acid and the nitric acid, is used.

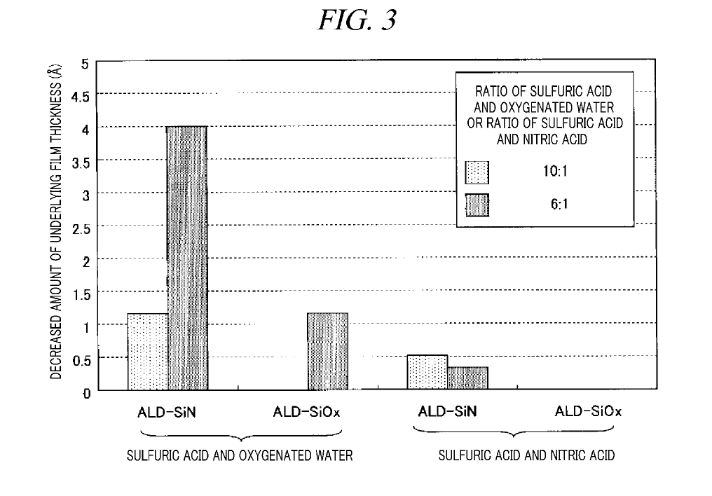

FIG. 3 is a graph of a decreased amount of an underlying film thickness when removing the resist film in case of a comparative example 1 (SPM cleaning) and a test example 2 (mixed acid cleaning). The decreased amount of the underlying film thickness t when removing the resist film is obtained by calculating a difference between underlying film thicknesses t1 and t2 before and after the removal of the resist film.

In the comparative example 1, the sulfuric acid and the oxygenated water are mixed at a flow rate ratio of about 10:1 or about 6:1. In the test example 2, the sulfuric acid and the nitric acid are mixed at a flow rate ratio of about 10:1 or about 6:1. Moreover, the temperature of the processing solution is set to be about 170° C., and the processing time is set to be about 2 minutes. In both of the comparative example 1 and the test example 2, a wafer W having thereon, as underlying films, SiN (ALD-SiN) formed by an atomic layer deposition method (ALD method) and SiOₓ (ALD-SiOₓ) formed by the atomic layer deposition method (ALD method) is used.

As shown in FIG. 3, when the underlying film is either ALD-SiN or ALD-SiOₓ or when the mixture ratio is either 10:1 or 6:1, the decreased amount of the underlying film thickness in the test example 2 is smaller than or equal to that in the comparative example 1 under the same conditions. Therefore, the resist film can be removed without removing the underlying film and the sidewall film by supplying the mixture of the sulfuric acid and the nitric acid serving as the processing solution onto the wafer W.

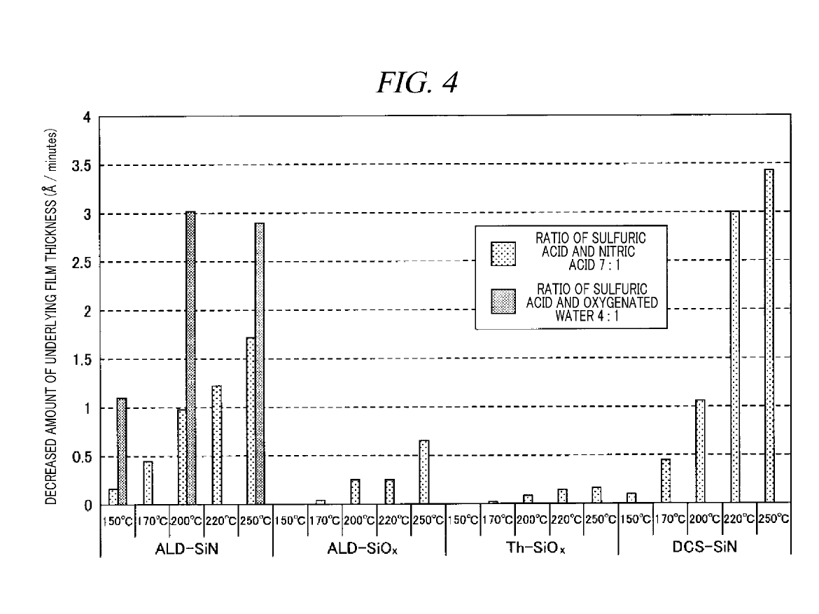

FIG. 4 is a graph of etching rates of various underlying films at various temperatures of the processing solution when removing a resist film in the test example 3 (mixed acid cleaning). In FIG. 4, the test example 3 is compared with the comparative example 2 (SPM cleaning) under some of the conditions.

In the test example 3, the mixture ratio of the sulfuric acid to the nitric acid is about 7:1 at a flow rate ratio (or a volume ratio can be used in actual processing conditions). In the comparative example 2, the mixture ratio of the sulfuric acid to the oxygenated water is about 4:1 at a flow rate ratio. Moreover, the temperature of the processing solution is set to be one of about 150° C., 170° C., 200° C., 220° C., and 250° C. Further, in the test example 3, a wafer W having, as an underlying film, any one of ALD-SiN, ALD-SiOₓ, SiOₓ (Th—SiOₓ) formed by thermal oxidation, and SiN (DCS SiN) formed by dichlorosilane gas is used. The comparative example 2 (SPM cleaning) is also performed in a case where the underlying film is ALD-SiN and the temperature of the processing solution is set to any one of about 150° C., 200° C. and 250° C.

When the underlying film is ALD-SiN, the etching rate of the underlying film in the test example 3 (mixed acid cleaning) is lower than that in the test example 2 (SPM cleaning), as can be seen from FIG. 4. Although FIG. 4 shows the result of the comparative example 2 (SPM cleaning) only under the condition that the underlying film is ALD-SiN, the same result can be also obtained under the condition that the underlying film is any one of ALD-SiOₓ, Th—SiOₓ and DCS-SiN. Therefore, it is possible to reduce the etching rate of the underlying film in case of removing the resist film by the mixed acid cleaning as compared to that in case of removing the resist film by the SPM cleaning.

In order to improve the removal performance of the resist film, the temperature of the processing solution needs to be increased. However, the etching rates for all of the underlying films are increased as the temperature of the processing solution is increased, as can be seen from FIG. 4. As a result, when the underlying film is ALD-SiN, for example, the underlying film thickness is reduced by about 8.5 Å under the conditions where the cleaning process is performed for about 5 minutes by using the mixed acid having a temperature of about 250° C., that allows the resist film to be removed.

Accordingly, in a LDD process or the like in which silicon loss may occur and an ion implantation depth is shallow since the dose of ions implanted into the wafer W is relatively small, e.g., about 10¹⁴ to 10¹⁵ ions/cm², it is desirable that the liquid processing method is performed at a temperature of about 120° C. to 200° C. Meanwhile, in a SD process or the like in which an ion implantation depth is deep since the dose of ions implanted into the wafer W is relatively large, e.g., about 10¹⁵ ions/cm² or larger, it is desirable the liquid processing method is performed at a temperature of about 200° C. to about 250° C.

### First Modification of the First Embodiment

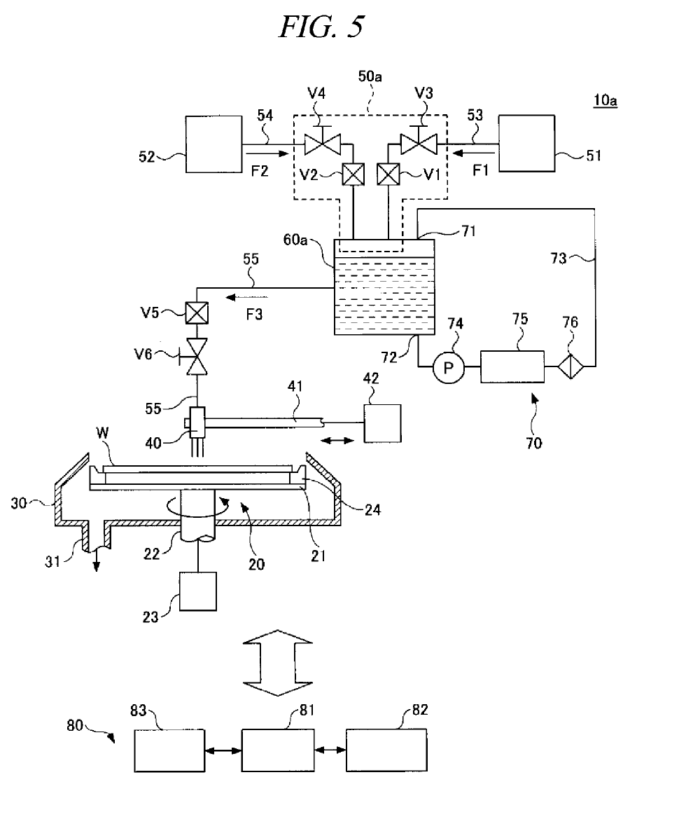

Next, a schematic configuration of a liquid processing apparatus in accordance with a first modification of the first embodiment of the present disclosure will be described with reference to FIG. 5.

The liquid processing apparatus of the present modification is different from the liquid processing apparatus of the first embodiment in that the sulfuric acid and the nitric acid are heated in a mixed state.

FIG. 5 shows the schematic configuration of the liquid processing apparatus of the present modification.

The liquid processing apparatus 10a includes the wafer supporting unit 20, the liquid drain cup 30, the supply nozzle 40, a switching unit 50a, the first supply source 51, the second supply source 52, a storage tank 60a, the circulation device 70, and the controller 80. Since the configuration of the liquid processing apparatus 10a other than the switching unit 50a, the first supply source 51, the second supply source 52 and the storage tank 60a are the same as those of the liquid processing apparatus 10 of the first embodiment. Hence, redundant description thereof will be omitted.

The switching unit 50a switchably connects the first supply source 51 and the second supply source 52 to the supply nozzle 40.

The first supply source 51 supplies sulfuric acid. The second supply source 52 supplies nitric acid. The first supply source 51 is connected to the switching unit 50a via the first supply path 53. The second supply source 52 is connected to the switching unit 50a via the second supply path 54. The switching unit 50a is connected to the supply nozzle 40 via the third supply path 55.

The switching unit 50a has the valves V1, V2, V3 and V4. The valve V1 is provided on the first supply path 53. The valve V2 is provided on the second supply path 54. The valves V1 and V2 are provided to be openable/closable independently. The valve V3 is provided on the first supply path 53 at the upstream side of the valve V1. The valve V4 is provided on the second supply path 54 at the upstream side of the valve V2. The valves V3 and V4 are configured to independently control the opening degrees thereof.

By switching opening/closing of the valves V1 and V2 independently and controlling the opening degrees of the valves V3 and V4 independently, the switching unit 50a can mix the sulfuric acid supplied by the first supply source 51 and the nitric acid supplied by the second supply source 52 at a certain ratio. The volume ratio of the sulfuric acid to the nitric acid may be set to be, e.g., about 2:1 to about 50:1.

In addition, instead of the valves V3 and V4, it is possible to use various flow rate controllers such as LFC, MFC, or the like. Further, the mixture ratio of the sulfuric acid and the nitric acid may be adjusted by controlling the intermittent opening/closing of the valves V1 and V2 without installing the valves V3 and V4.

The storage tank 60a is provided on the third supply path 55 between the switching unit 50a and the supply nozzle 40. The storage tank 60a is configured to store therein the processing solution including the sulfuric acid and the nitric acid mixed by the switching unit 50a.

The switching unit 50a and the storage tank 60a correspond to a mixing unit in the present disclosure.

The circulation device 70 has the supply port 71, the outlet port 72, the circulation path 73, the pump 74, the heater 75, and the filter 76. The supply port 71 is formed at, e.g., an upper portion of the storage tank 60a. The outlet port 72 is formed at, e.g., a bottom portion of the storage tank 60a. The circulation path 73 connects the outlet port 72 and the supply port 71 of the storage tank 60a. The pump 74, the heater 75, and the filter 76 are provided on the circulation path 73 in sequence from the outlet port 72 side, for example. The pump 74 serves as a liquid transporting unit for transporting the processing solution from the storage tank 60a to the supply port 71. The heater 75 is configured to heat the processing solution transported to the supply port 71 to a certain temperature. That is, the heater 75 serves as a heating unit for controlling a processing solution at a certain temperature. The controlled temperature may be set to be, e.g., about 120° C. to about 250° C. The filter 76 serves as a purifying unit for purifying the processing solution transported from the storage tank 60a.

The circulation device 70 discharges the processing solution from the outlet port 72 of the storage tank 60a by the pump 74. Next, the discharged processing solution is heated by the heater 75 and, then, the heated processing solution is purified by the filter 76. Thereafter, the purified processing solution is transported to the supply port 71 by the pump 74. Next, the transported processing solution is introduced to the storage tank 60a again through the supply port 71. In this manner, the processing solution is circulated.

The circulation device 70 can transport the processing solution at a certain flow rate of, e.g., about 10 L/min (circulation flow rate) from the outlet port 72 to the supply port 71 by the pump 74.

The valves V5 and V6 are provided on the third supply path 55 between the storage tank 60a and the supply nozzle 40. The valve V5 is configured to be openable/closable. The valve V6 is provided at the downstream side of the valve V5 and is configured to control the opening degree thereof.

Further, a pure water supply source (not shown) may be connected on the third supply path 55 between the valve V6 and the supply nozzle 40 via a switching unit (not shown). Alternatively, a pure water supply nozzle (not shown) different from the supply nozzle 40 may be provided and the pure water supply source (not shown) may be connected to the pure water supply nozzle. In this way, a pure water rinsing can be performed after performing the process using the processing solution in the liquid processing apparatus 10a.

Further, a collecting unit (not shown) for connecting the liquid drain pipe 31 and the storage tank 60a may be provided. The collecting unit may collect the processing solution from the liquid drain pipe 31 by a pump (not illustrated), and the collected processing solution may be purified by a filter (not shown). Then, the purified processing solution may be returned into the storage tank 60a via a pump (not shown).

In the liquid processing method of the present modification, the resist film can be removed from the wafer W on which the gate insulating film and the resist film are formed in sequence from the bottom and into which ions have been previously implanted. This can be described with reference to FIG. 2.

A wafer W on which an underlying film was formed in advance is prepared, and the processes illustrated in FIGS. 2(a) and 2(b) are carried out as in the first embodiment.

Next, as shown in FIG. 2(c), the resist film 95 is removed from the wafer W into which ions have been previously implanted.

The wafer W is supported by the supporting member 24 of the wafer supporting unit 20. The wafer W supported by the supporting member 24 is rotated by rotating the rotation shaft 22 and the rotation plate 21 through the rotating motor 23. The supply nozzle 40 is moved to the processing solution supply position by the driving mechanism 42. Then, the processing solution is supplied onto the wafer W via the supply nozzle 40.

The controller 80 is configured to control the amounts of the sulfuric acid and the nitric acid supplied to the storage tank 60a from the first supply source 51 and the second supply source 52, respectively, by controlling the opening/closing or the opening degrees of the valves V1 to V4. For example, the sulfuric acid is supplied at the first flow rate F1 from the first supply source 51, and the nitric acid is supplied at the second flow rate F2 from the second supply source 52. Therefore, the sulfuric acid and the nitric acid are mixed at a certain ratio to be stored in the storage tank 60a.

The controller 80 controls the heater 75 to heat the processing solution such that the temperature of the processing solution supplied onto the wafer W becomes higher than or equal to about 120° C. For example, a temperature sensor (not shown) may be installed near the supply nozzle 40. Then, the temperature of the processing solution supplied via the supply nozzle 40 is measured by the temperature sensor. Further, the controller 80 controls power supplied to the heater 75 such that the temperature measured by the temperature sensor becomes higher than or equal to about 120° C. Therefore, the processing solution stored in the storage tank 60a is maintained at a certain temperature higher than or equal to about 120° C. The processing solution stored in the storage tank 60a may be maintained at a temperature higher than, for example, a preset temperature of the processing solution supplied by the supply nozzle 40.

The controller 80 supplies the processing solution at a third flow rate F3 from the storage tank 60a to the supply nozzle 40 by opening the valve V5 and by controlling an opening degree of the valve V6. Accordingly, the sulfuric acid and the nitric acid mixed at a certain ratio by the switching unit 50a can be supplied, as the processing solution having a temperature of about 120° C. or higher, onto the wafer W by the supply nozzle 40.

As shown in FIG. 2(c), the resist film 95 is removed from the wafer W by supplying the processing solution onto the wafer W. At this time, the resist film 95 can be removed without removing the gate insulating film 92 and the sidewall film 94 as in the first embodiment.

As in the first embodiment, it is desirable that the controller 80 controls the switching unit 50a such that the sulfuric acid and the nitric acid are mixed at a volume ratio of about 2:1 to about 50:1. More desirably, the sulfuric acid and the nitric acid are mixed at a volume ratio of about 4:1 to about 10:1. In other words, it is desirable to mix the sulfuric acid and the nitric acid such that the ratio of the first flow rate F1 to the second flow rate F2 is about 2:1 to about 50:1. It is more desirable to mix the sulfuric acid and the nitric acid such that the ratio of the first flow rate F1 to the second flow rate F2 is about 4:1 to about 10:1.

As in the first embodiment, it is desirable that the controller 80 controls the heater 75 such that the temperature of the supplied processing solution is about 120° C. to about 250° C.

As in the first embodiment, it is desirable that the controller 80 supplies the sulfuric acid and the nitric acid serving as the processing solution for about 2 minutes.

Further, the controller 80 may supplement the sulfuric acid or the nitric acid from the first supply source 51 or the second supply source 52, respectively, by controlling the opening/closing or the opening degrees of the valves V1 to V4. As a result, the controller 80 may maintain a certain mixture ratio of the sulfuric acid to the nitric acid stored in the storage tank 60a.

Thereafter, a pure water rinsing process is performed by supplying pure water onto the wafer W from a pure water supply source (not shown) via the supply nozzle 40 or from a pure water supply source (not shown) via a pure water supply nozzle (not shown). Next, the cleaning process is completed by performing a spin dry or a N₂ dry, if necessary.

In the present modification, as in the first embodiment, the resist film is removed by supplying to the wafer W the processing solution that has the sulfuric acid and the nitric acid mixed at a certain ratio and that is maintained at a temperature of about 120° C. or higher. Accordingly, the resist film can be removed without removing the underlying film and the sidewall film.

### Second Modification of the First Embodiment

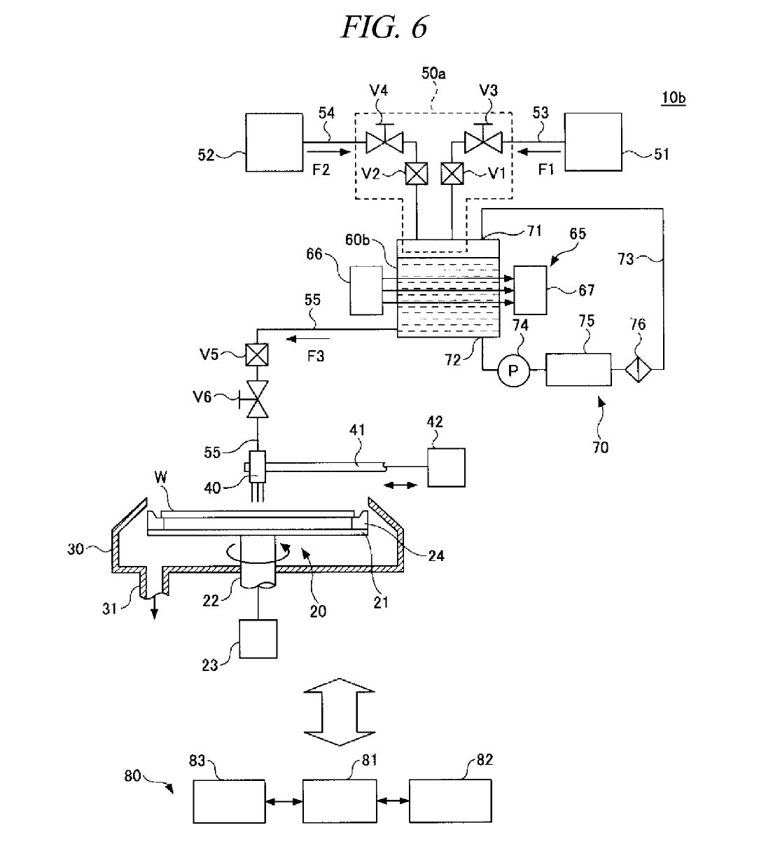

Next, a schematic configuration of a liquid processing apparatus of the second modification of the first embodiment of the present disclosure will be described with reference to FIG. 6.

The liquid processing apparatus of the present modification is different from the liquid processing apparatus of the first modification of the first embodiment in that intensity of nitronium ions (NO₂⁺) is measured by an ion intensity measurement unit.

FIG. 6 shows the schematic configuration of the liquid processing apparatus of the present modification.

In a liquid processing apparatus 10b of the present modification, an ion intensity measurement unit 65 is provided, and a storage tank 60b is made of quartz. The liquid processing apparatus 10b of the present modification is the same as the liquid processing apparatus 10a of the first modification of the first embodiment except for the ion intensity measurement unit 65 and the storage tank 60b. Accordingly, the redundant description thereof will be omitted.

The ion intensity measurement unit 65 includes a light emitting unit 66 for irradiating light having a certain wavelength to the storage tank 60b from the outside, and a light receiving unit 67 for receiving the light transmitted from the processing solution stored in the storage tank 60b after being irradiated from the light emitting unit 66. The light emitting unit 66 and the light receiving unit 67 are provided at an outside of the storage tank 60b. The light receiving unit 67 is provided at a position opposite to the position where the light emitting unit 66 is provided. Since the storage tank 60b is made of quartz, the light irradiated from the light emitting unit 66 enters the light receiving unit 67 after passing through the processing solution stored in the storage tank 60b.

In the liquid processing method of the present modification, the resist film is removed from the wafer W on which the gate insulating film and the resist film are formed in sequence from the bottom and into which ions have been previously implanted. This can be described with reference to FIG. 2. In the present modification, the ion intensity of NO₂⁺ is measured by the ion intensity measurement unit 65. The liquid processing method of the present modification is the same as the liquid processing method of the first modification of the first embodiment except that the ion intensity of NO₂⁺ is measured. Hence, the redundant description thereof will be omitted.

In the liquid processing method of the present modification, a table storing data on a relationship between an ion intensity of NO₂⁺ and an intensity of light received by the light receiving unit 67 has been previously generated by measuring the intensity of the light received by the light receiving unit 67 while varying the ion intensity of NO₂⁺ in the processing solution stored in the storage tank 60b. In an actual liquid processing, the ion intensity of NO₂⁺ in the processing solution stored in the storage tank 60b is measured based on the intensity of the light received by the light receiving unit 67 and the data stored in the table.

Here, the ion intensity may be determined based on both of concentration of NO₂⁺ and activity of NO₂⁺ or either one of concentration of NO₂⁺ or activity of NO₂⁺.

Further, the controller 80 can control at least one of the heating amount of the heater 75, the supplement amount of the sulfuric acid to the storage tank 60b from the first supply source 51, and the supplement amount of the nitric acid supplemented to the storage tank 60b from the second supply source 52 based on the ion intensity measured by the ion intensity measurement unit 65.

For example, when a processing solution including the sulfuric acid and the nitric acid at a volume ratio of about 7:1 is uniformly heated at a temperature of about 50° C. to about 250° C., the processing solution has initially turned brown at the temperature of about 150° C. The degree of turning brown is maximized at the temperature of about 210° C. to about 230° C. When the processing solution turns brown, it may be considered that concentration of NO₂⁺ or activity of NO₂⁺ is increased. Further, when the processing solution turns brown, the light amount received by the light receiving unit 67 is decreased. Therefore, the concentration of NO₂⁺ or the activity of NO₂⁺ can be controlled to be higher than or equal to a certain minimum value by controlling the heating amount of the heater 75 or the like such that the light amount received by the light receiving unit 67 is decreased to be lower than or equal to a certain maximum value.

Even when the processing solution is heated at a constant temperature for a certain period of time, the degree of turning brown of the processing solution is also increased as the ion intensity of NO₂⁺ in the processing solution is increased. For example, if the processing solution is supplied onto the wafer W after increasing the degree of turning brown, i.e., the ion intensity, by heating at about 200° C. for a certain period of time (e.g., about 10 minutes), the resist removal performance substantially the same as the case of heating the processing solution at a temperature higher than about 200° C. can be achieved. As a result, it is possible to suppress the cost increase for ensuring the heat resistance of each component of the apparatus, and to improve the resist removal performance.

### Second Embodiment

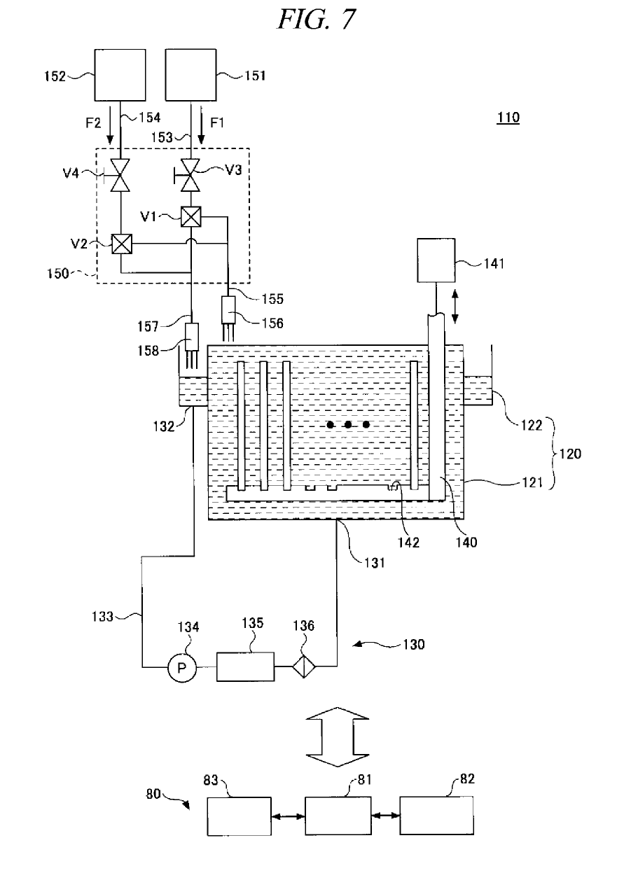

Hereinafter, a schematic configuration of a liquid processing apparatus of a second embodiment of the present disclosure will be described with reference to FIG. 7.

The liquid processing apparatus of the present embodiment is different from the liquid processing apparatus of the first embodiment in that the liquid processing apparatus of the present disclosure is applied to a batch type liquid processing apparatus for processing multiple wafers W at a time.

FIG. 7 shows a schematic configuration of the liquid processing apparatus of the present embodiment.

The liquid processing apparatus 110 includes a processing tub 120, a circulation device 130, a wafer guide 140, a switching unit 150, a first supply source 151, a second supply source 152 and, a controller 80. Since the controller 80 of the present embodiment is the same as that of the liquid processing apparatus 10 of the first embodiment, the description thereof will be described.

The processing tub 120 stores therein a processing solution for processing the wafer W, and has an inner tub 121 and an outer tub 122. The inner tub 121 has a box shape, and has a sufficient size enough to accommodate therein wafers W. The inner tub 121 stores therein the processing solution.

The outer tub 122 is provided outside the inner tub 121. The outer tub 122 is provided so as to surround an opening of the inner tub 121. The outer tub 122 is configured to receive the processing solution overflowing from the inner tub 121.

The inner tub 121 and the outer tub 122 are made of a material having corrosion resistance and chemical resistance, e.g., quartz.

The circulation device 130 has a supply port 131, an outlet port 132, a circulation path 133, a pump 134, a heater 135, and a filter 136. The supply port 131 is formed at, e.g., the bottom portion of the inner tub 121. The outlet port 132 is formed at, e.g., the bottom portion of the outer tub 122. The circulation path 133 connects the outlet port 132 and the supply port 131. The pump 134, the heater 135, and the filter 136 are provided on the circulation path 133 in sequence from the outlet port 132 side, for example. The pump 134 serves as a liquid transporting unit for transporting the processing solution from the outer tub 122 to the supply port 131. The heater 135 is configured to heat the processing solution transported to the supply port 131 to a certain temperature. That is, the heater 135 serves as a heating unit for controlling a processing solution at a certain temperature. The controlled temperature may be set to be, e.g., about 120° C. to about 250° C. The filter 136 serves as a purifying unit for purifying the processing solution transported from the outer tub 122.

The circulation device 130 circulates the processing solution in the following manner. The processing solution in the outer tub 122 is discharged through the outlet port 132 of the outer tub 122 by the pump 134. Next, the discharged processing solution is heated by the heater 135 and, then, the heated processing solution is purified by the filter 136. Thereafter, the purified processing solution is transported to the supply port 131 by the pump 134. Next, the transported processing solution is introduced to the inner tub 121 through the supply port 131.

The circulation device 130 can transport the processing solution at a certain flow rate of, e.g., about 10 L/min (circulation flow rate) from the outlet port 132 of the outer tub 122 to the supply port 131 of the inner tub 121 by the pump 134.

Further, a pure water supply source (not shown) may be connected between, e.g., the filter 136 and the supply port 131, via a switching unit (not shown). In this way, a pure water rinsing process can be performed after performing the process using the processing solution in the processing tub 120.

The wafer guide 140 is provided in the inner tub 121 so as to support the wafer W. The wafer guide 140 corresponds to the substrate supporting unit of the present disclosure. The wafer guide 140 may be vertically moved between a position in the inner tub 121 and a position above the inner tub 121 by an elevating mechanism 141.

A multiple number of, e.g., fifty, grooves 142 are formed at the wafer guide 140 at regular intervals. The lower peripheral portion of the wafer W is inserted into the grooves 142 to be supported. The wafer guide 140 is configured to support a multiple number of, e.g., fifty, wafers W at regular intervals by inserting the peripheral portions of the wafers W into the grooves 142.

In the present embodiment, the wafer guide 140 supporting the wafer W is moved down by the elevating mechanism 141 into the inner tub 121 storing the processing solution. As a result, the wafer W is immersed in the processing solution so that the processing solution can be supplied onto the wafer W. In other words, the inner tub 121 corresponds to the supply unit of the present disclosure.

The switching unit 150 switchably connects the first supply source 151 and the second supply source 152 to the processing tub 120.

The first supply source 151 supplies sulfuric acid. The second supply source 152 supplies nitric acid. The first supply source 151 is connected to the switching unit 150 via the first supply path 153. The second supply source 152 is connected to the switching unit 150 via the second supply path 154. The switching unit 150 is connected to a supply nozzle 156 for supplying the processing solution into the inner tub 121 via a third supply path 155. Moreover, the switching unit 150 is connected to a supply nozzle 158 for supplying the processing solution into the outer tub 122 via a fourth supply path 157.

The switching unit 150 can directly supply the processing solution to the inner tub 121 through the supply nozzle 156. Therefore, it is possible to reduce the time required to prepare the processing solution after the processing solution is exchanged, for example.

The switching unit 150 has the valves V1, V2, V3, and V4. The valve V1 is provided on the first supply path 153. The valve V2 is provided on the second supply path 154. The valve V1 is configured to switchably connect the first supply path 153 to the supply nozzle 156 or to the supply nozzle 158 by switching, e.g., a three-way valve. The valve V2 is configured to switchably connect the second supply path 154 to the supply nozzle 156 or to the supply nozzle 158 by switching, e.g., a three-way valve. The valves V1 and V2 are configured to be capable of switching independently. The valve V3 is provided on the first supply path 153 at the upstream side of the valve V1. The valve V4 is provided on the second supply path 154 at the upstream side of the valve V2. The valves V3 and V4 are configured to independently control the opening degrees thereof.

By switching the opening/closing of the valves V1 and V2 independently and controlling opening degrees of the valves V3 and V4 independently, the switching unit 150 can mix the sulfuric acid supplied from the first supply source 151 and the nitric acid supplied from the second supply source 152 at a certain ratio. The volume ratio of the sulfuric acid to the nitric acid may be set to be, e.g., about 2:1 to about 50:1.

When the processing solution is stored in the empty inner tub 121 for the first time, the processing solution can be directly supplied to the inner tub 121 through the supply nozzle 156 connected to the switching unit 150 via the third supply path 155. At this time, the switching unit 150 and the inner tub 121 correspond to a mixing unit of the present disclosure.

When the processing solution has been previously stored in the inner tub 121, the processing solution can be additionally supplied to the outer tub 122 through the supply nozzle 158 connected to the switching unit 150 via the fourth supply path 157. At this time, both of the sulfuric acid and the nitric acid may be supplemented, or either one of the sulfuric acid or the nitric acid may be supplemented by switching the switching unit 150 such that the sulfuric acid and the nitric acid in the processing solution are mixed at a certain ratio. The sulfuric acid or the nitric acid supplemented to the outer tub 122 through the supply nozzle 158 is transported to the inner tub 121 via the circulation device 130. The mixture ratio of the sulfuric acid to the nitric acid in the processing solution stored in the inner tub 121 is controlled to be a certain value. At this time, the switching unit 150, the outer tub 122, the circulation device 130, and the inner tub 121 correspond to the mixing unit of the present disclosure.

Instead of the valves V3 and V4, it is possible to use various flow rate controllers such as LFC, MFC, or the like.

In the liquid processing method of the present embodiment, the resist film is removed from the wafer W on which the gate insulating film and the resist film are formed in sequence from the bottom and into which ions have been previously implanted. This can be described with reference to FIG. 2.

The wafer W on which an underlying film was formed in advance is prepared, and the processes illustrated in FIGS. 2(a) and 2(b) are carried out as in the first embodiment.

Next, as shown in FIG. 2(c), the resist film 95 is removed from the wafer W into which ions have been previously implanted.

In a state where the processing solution is stored in the inner tub 121, the wafer W is supported by the wafer guide 140, and then, the wafer guide 140 is moved down into the inner tub 121 by the elevating mechanism 141. In this way, the wafer W is immersed in the processing solution so that the processing solution can be supplied onto the wafer W.

The controller 80 is configured to control the amounts of the sulfuric acid and the nitric acid supplied to the processing tub 120 from the first supply source 151 and the second supply source 152, respectively, by controlling the opening/closing or the opening degrees of the valves V1 to V4. For example, the sulfuric acid is supplied at the first flow rate F1 from the first supply source 151, and the nitric acid is supplied at the second flow rate F2 from the second supply source 152. Hence, the sulfuric acid and the nitric acid mixed at a certain ratio can be stored in the processing tub 120.

The controller 80 controls the heater 135 to heat the processing solution such that the temperature of the processing solution supplied onto the wafer W, i.e., the temperature of the processing solution stored in the inner tub 121, becomes higher than or equal to about 120° C. For example, a temperature sensor (not shown) may be installed near the inner tub 121. Then, the temperature of the processing solution stored in the inner tub 121 is measured by the temperature sensor. Further, the controller 80 controls power supplied to the heater 135 such that the temperature measured by the temperature sensor becomes higher than or equal to about 120° C. As a consequence, the processing solution stored in the inner tub 121 may be maintained at the temperature of about 120° C. or higher.

As shown in FIG. 2(c), the resist film 95 is removed from the wafer W by supplying the processing solution onto the wafer W. At this time, the resist film 95 can be removed without removing the gate insulating film 92 and the sidewall film 94.

As in the first embodiment, it is desirable that the controller 80 controls the switching unit 150 such that the sulfuric acid and the nitric acid are mixed at a volume ratio of about 2:1 to about 50:1. More desirably, the sulfuric acid and the nitric acid are mixed at a volume ratio of about 4:1 to about 10:1. In other words, it is desirable to mix the sulfuric acid and the nitric acid such that the ratio of the first flow rate F1 to the second flow rate F2 is about 2:1 to about 50:1. It is more desirable to mix the sulfuric acid and the nitric acid such that the ratio of the first flow rate F1 to the second flow rate F2 is about 4:1 to about 10:1.

As in the first embodiment, it is desirable that the controller 80 controls the heater 135 such that the temperature of the supplied processing solution is about 120° C. to about 250° C.

As described above, the controller 80 may maintain the mixture ratio of the sulfuric acid to the nitric acid stored in the processing tub 120 at a certain value by supplementing the sulfuric acid or the nitric acid from the first supply source 151 or the second supply source 152, respectively, by controlling the opening/closing or the opening degrees of the valves V1 to V4.

Thereafter, a pure water rinsing process is performed by supplying pure water from a pure water supply source (not shown) to the inner tub 121 via the circulation path 133. Alternately, a pure water rinsing process is performed in a pure water rinsing tub, different from the processing tub 120, storing pure water. Next, the cleaning process is completed by performing a N₂ dry, if necessary.

In the present embodiment, as in the first embodiment, the resist film is removed by supplying to the wafer W the processing solution that has the sulfuric acid and the nitric acid mixed at a certain ratio and that is maintained at a temperature of about 120° C. or higher. Accordingly, the resist film can be removed without removing the underlying film and the sidewall film.

Although the embodiments of the disclosure have been described, the present disclosure is not limited to the above-described embodiments, and various changes and modification may be made without departing from the scope of the disclosure as defined in the following claims.

For example, a substrate to be processed may be various types of substrates other than a semiconductor substrate. Further, an underlying film formed on a substrate may be various types of films such as a protective film for protecting a surface of a substrate, a conductive film formed on a surface of a substrate, or the like.

What is claimed is:

1. A liquid processing method for processing a substrate by a processing solution, the method comprising:
removing a resist film from the substrate by supplying a processing solution at a temperature of about 120° C. or higher to the substrate,
wherein the processing solution includes a sulfuric acid and a nitric acid at a preset ratio, and
the substrate has thereon a underlying film and the resist film formed on the underlying film, and ions have been previously implanted into the substrate.

2. A liquid processing method for processing a substrate by a processing solution, the method comprising:
supporting the substrate by a substrate supporting unit;
generating a processing solution by mixing a sulfuric acid and a nitric acid mixed at a preset ratio in a mixing unit; and
removing a resist film from the substrate by supplying the processing solution at a temperature of about 120° C. or higher to the substrate from a supply unit,
wherein the substrate has thereon a underlying film and the resist film formed on the underlying film, and ions have been previously implanted into the substrate.

3. The liquid processing method of claim 2, wherein the resist film is removed from the substrate by heating the sulfuric acid in a heating unit such that the temperature of the processing solution is about 120° C. or higher; and mixing the heated sulfuric acid and the nitric acid in the mixing unit; supplying the mixed sulfuric acid and the nitric acid as the processing solution to the substrate from the supply unit.

4. The liquid processing method of claim 2, wherein the resist film is removed from the substrate by heating the sulfuric acid and the nitric acid in a heating unit such that the temperature of the processing solution is about 120° C. or higher; and supplying the heated sulfuric acid and nitric acid as the processing solution to the substrate from the supply unit.

5. The liquid processing method of claim 4, wherein the mixing unit includes a storage tank for storing therein a mixture of the sulfuric acid and the nitric acid as the processing solution, and
the method further includes:
irradiating a light into the storage tank by a light emitting unit;
receiving the light transmitted from the processing solution stored in the storage tank by a light receiving unit;
measuring an intensity of nitronium ions in the processing solution stored in the storage tank based on light amount received by the light receiving unit; and
controlling a heating amount of the heating unit, a supplement amount of the sulfuric acid into the storage tank, or a supplement amount of the nitric acid into the storage tank.

6. The liquid processing method of claim 2, wherein the temperature of the processing solution ranges from about 120° C. to about 250° C.

7. The liquid processing method of claim 1, wherein the sulfuric acid and the nitric acid is mixed such that a volume ratio of the sulfuric acid to the nitric acid is about 2:1 to about 50:1.

8. The liquid processing method of claim 7, wherein the sulfuric acid and the nitric acid is mixed such that a volume ratio of the sulfuric acid to the nitric acid is about 4:1 to about 10:1.

9. The liquid processing method of claim 1, wherein the underlying film is a gate insulating film or a sidewall film for covering a side surface of a gate electrode.

10. A non-transitory computer-readable storage medium having stored thereon computer-readable instructions that, in response to execution, cause a liquid processing apparatus to perform a liquid processing method as claimed in claim 1.

11. A liquid processing apparatus for processing a substrate by a processing solution, the apparatus comprising:
a substrate supporting unit for supporting a substrate;
a mixing unit for mixing a sulfuric acid and a nitric acid;
a supply unit for supplying, as a processing solution, the sulfuric acid and the nitric acid mixed by the mixing unit to the substrate;
a heating unit for heating the sulfuric acid or the processing solution to a predetermined temperature; and
a controller for controlling the substrate supporting unit, the mixing unit, the supply unit and the heating unit,
wherein the controller controls the substrate supporting unit to support the substrate; controls the mixing unit to mix the sulfuric acid and the nitric acid at a preset ratio; controls the supply unit to supply the mixture of the sulfuric acid and the nitric acid at a temperature of about 120° C. or higher to the substrate; and controls the heating unit to heat the sulfuric acid or the processing solution, and
the substrate has thereon a underlying film and the resist film formed on the underlying film, and ions have been previously implanted into the substrate.

12. The liquid processing apparatus of claim 11, wherein the heating unit is configured to heat the sulfuric acid, and
the controller controls the heating unit to heat the sulfuric acid such that the temperature of the processing solution is about 120° C. or higher; controls the mixing unit to mix the heated sulfuric acid and the nitric acid; and controls the supply unit to supply the mixed sulfuric acid and nitric acid as the processing solution to the substrate.

13. The liquid processing apparatus of claim 11, wherein the heating unit is configured to heat the sulfuric acid and the nitric acid mixed by the mixing unit, and
the controller controls the heating unit to heat the mixed sulfuric acid and nitric acid such that the temperature of the processing solution is about 120° C. or higher; controls the supply unit to supply the heated sulfuric acid and nitric acid as the processing solution to the substrate.

14. The liquid processing apparatus of claim 13, wherein the mixing unit includes a storage tank for storing therein the mixed sulfuric acid and nitric acid as the processing solution,
the apparatus further includes an ion intensity measuring device that has a light emitting unit for irradiating a light into the storage tank; and a light receiving unit for receiving the light transmitted from the processing solution stored in the storage tank, and that measures an intensity of nitronium ions in the processing solution stored in the storage tank based on light amount received by the light receiving unit, and
the controller controls a heating amount of the heating unit, a supplement amount of the sulfuric acid into the storage tank, or a supplement amount of the nitric acid into the storage tank.

15. The liquid processing apparatus of claim 11, wherein the controller controls the heating unit such that a temperature of the processing solution is about 120° C. to about 250° C.

16. The liquid processing apparatus of claim 11, wherein the controller controls the mixing unit such that a volume ratio of the sulfuric acid to the nitric acid is about 2:1 to 50:1.

17. The liquid processing apparatus of claim 16, wherein the controller controls the mixing unit such that a volume ratio of the sulfuric acid to the nitric acid is about 4:1 to 10:1.

18. The liquid processing apparatus of claim 11, wherein the underlying film is a gate insulating film or a sidewall film for covering a side surface of a gate electrode.
